(19) United States
(12) Patent Application Publication
(10) Pub. No.: US 2009/0171780 A1
(43) Pub. Date: Jul. 2, 2009

(54) METHODS AND SYSTEM FOR A TARGETED ADVERTISEMENT MANAGEMENT INTERFACE

(75) Inventors: Raul ALDREY, Dallas, TX (US); Nishanth Reddy Vontela, Irving, TX (US); Dolapo T. Olumide Kukoyi, Irving, TX (US); Ifeyinwa Obi, Irving, TX (US); Sudhanshu Sharma, Malden, MA (US); Anil K. Solleti, Irving, TX (US)

Correspondence Address: VERIZON;PATENT MANAGEMENT GROUP, 1320 North Court House Road, 9th Floor, ARLINGTON, VA, 22201-2909, US

(73) Assignee: Verizon Data Services Inc., Temple Terrace, FL (US)

(21) Appl. No.: 11/967,477

(22) Filed: Dec. 31, 2007

(51) Int. Cl. G06Q 30/00; G06Q 90/00

(52) U.S. Cl. 705/14; 705/1

(57) ABSTRACT

A system and method can include entering targeted advertisements for multiple types of targeted consumer devices, managing associated targeted advertisement campaigns, sending a targeted advertisement to a targeted consumer device over a network, and receiving receptivity data associated with the targeted advertisement from the targeted consumer device. The targeted advertisement can be associated with a targeted advertisement campaign and can be based on a profile associated with a targeted consumer device and rules associated with the targeted advertisement campaign.

### BACKGROUND INFORMATION

Typically, it is difficult for an advertiser to determine if a television advertisement is viewed by a consumer. As digital video recorders become more popular, the uncertainty of whether a consumer has viewed an advertisement increases. Although the Nielsen Ratings can provide an advertiser with the number of households that tuned into a given television program (using various measurement and statistical methods), the advertiser may not know how many viewers fast forwarded through a given advertisement. Similarly, an advertiser can determine how many households download a video on demand, but the advertisers do not know if viewers fast forwarded through an advertisement in a preview.

In addition, depending on the medium, advertisers cannot target specific consumers with much specificity. For example, advertisers can only choose television programs and videos in which to place advertisements. For television advertisements, they can choose the time and programs. In addition, the advertiser is paying money for an advertisement that may only be directed at a percentage of the viewing audience.

### BRIEF DESCRIPTION OF THE DRAWINGS

FIG. 1 illustrates a general overview of a marketing system in accordance with an exemplary embodiment;

FIG. 2 illustrates a block diagram of a targeted advertisement delivery system in accordance with an exemplary embodiment;

FIG. 3 illustrates an input device in accordance with an exemplary embodiment;

FIG. 4 illustrates a block diagram of the targeted advertisement management interface in accordance with an exemplary embodiment;

FIGS. 5A-5D illustrate screenshots for creating an advertisement in accordance with an exemplary embodiment;

FIG. 6 illustrates a flow diagram of a method in accordance with an exemplary embodiment;

FIGS. 7A-7C illustrate block diagrams of screenshots for displaying targeted advertisements in accordance with an exemplary embodiment.

These and other embodiments and advantages will become apparent from the following detailed description, taken in conjunction with the accompanying drawings, illustrating by way of example the principles of the various exemplary embodiments.

### DETAILED DESCRIPTION OF EXEMPLARY EMBODIMENTS

A system and method in accordance with exemplary embodiments can include a single system for generating and managing advertisement campaigns that deliver targeted advertisements to potential consumers across one or more delivery systems. A campaign management module enables users, e.g., advertisers and business owners, to build campaigns by designing advertisements for various media and devices. The campaign management module can allow the users to design the campaigns by generating rules defining the targeted audience. A targeting module can assist in scheduling the launching of advertisement campaigns through specific devices for delivery to the targeted audience. A decision support module can gather metrics on the effectiveness of advertisement campaigns and can assist users in tuning the advertisements and/or campaigns.

Using the system, users can deliver advertisements, such as video on demand (VOD), banner, interactive, video, text message, email advertisements to various devices, such as, televisions, set top boxes, computers, smart phones, cellular phones, and personal digital assistants. For example, if a consumer orders a video on demand, the system can insert a targeted advertisement into the requested video and send the requested video with the targeted advertisement to the requester. The inserted targeted advertisement can be based on information known about the potential consumer, e.g., using information stored in a user profile associated with the potential consumer. In another example, the system can insert a targeted advertisement into a banner advertisement to be displayed while the potential consumer is playing an on-line game. The banner advertisement can prompt the potential consumer to click on the banner to see a short advertisement video. The system can monitor the potential consumer's interactions to determine the effectiveness of the targeted advertisement. If the potential consumer views the short advertisement video, the system can use the potential consumer's interactions to send other targeted advertisements to another device associated with that potential consumer. For example, if the potential consumer elected to watch a short video advertisement for a new automobile, the system can access a user profile to obtain the consumer's cellular telephone number to send a text message advertisement to the potential consumer advertising new car loans. In yet another example, an interactive advertisement can include overlay content, triggers, and return paths for user interaction. The overlay content and triggers can be delivered to a client device 208 (e.g., a set top box (STB)) over the out-of-band (OOB) or in-band channels as part of a multiplex and user interactions can be sent through a return path over a network, such as, but not limited to, Internet Protocol (IP) or Radio Frequency.

The description below describes servers, computers, terminals, client devices, and other computing devices that can include one or more modules, some of which are explicitly depicted in the figures, others are not. As used herein, the term “module” may be understood to refer to software, firmware, hardware, and/or various combinations thereof. It is noted that the modules are exemplary. The modules can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another (e.g., servers). Additionally, the modules can be moved from one device and added to another device, and/or can be included in both devices. It is further noted that the software described herein can be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, computers, terminals, client devices, etc.) separately. The functions described as being performed at various components can be performed at other components, and the various components can be combined and/or separated. Other modifications also can be made.

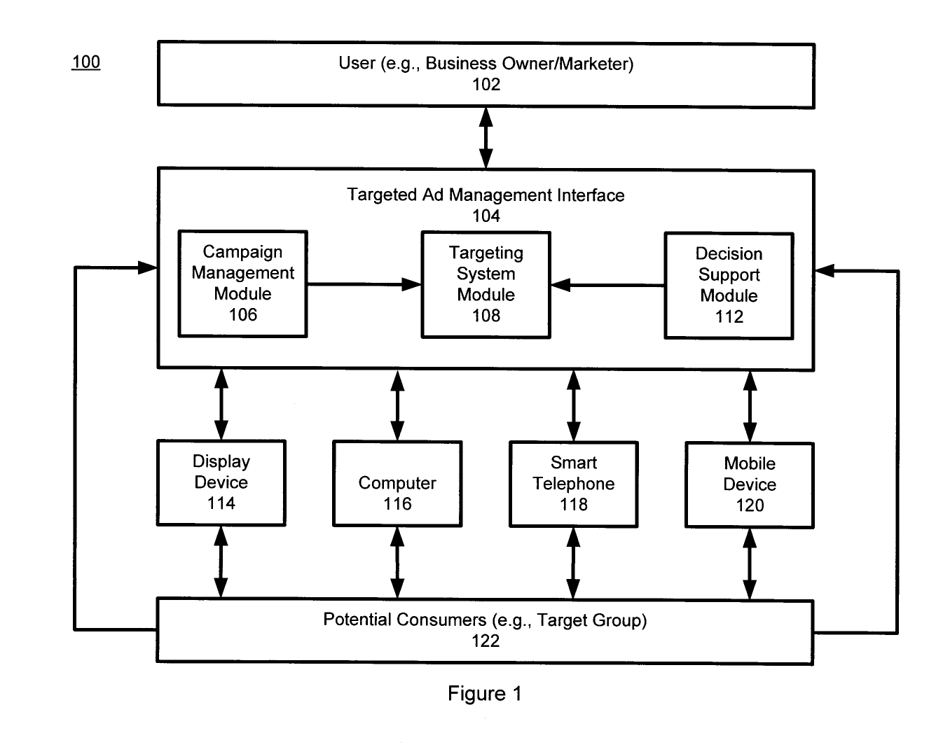

Referring to FIG. 1, a general overview of a marketing system in accordance with an exemplary embodiment is illustrated. It should be appreciated that the system shown in FIG. 1 is a simplified view of a marketing system 100 and may include additional elements that are not depicted. As shown, the marketing system 100 can assist a user 102, e.g., a business owner, marketer, advertisement personnel, in developing and monitoring an advertisement campaign using a targeted advertisement management interface 104. The targeted advertisement management interface 104 can provide targeted advertisements through targeted consumer devices to a targeted demographic audience. The targeted advertisements can include, but are not limited to, banner, interactive, video on demand (VOD), video, Short Messaging Services (SMS)(e.g., text messaging), and email advertisements. The targeted advertisements can also include links to the targeted advertisement, e.g., a banner advertisement can include a link to a video advertisement. The targeted consumer devices can include, but are not limited to, display devices 114 (e.g., televisions), computers 116, smart telephones 118 (e.g., Verizon One), and mobile devices 120 (e.g., cellular phones, satellite phones, personal digital assistant). A user 102 can interact with the campaign management module 106 to build an advertisement campaign by designing advertisements for various media and devices. The various media can include, but are not limited to, webpages, video on demand (VOD), Short Message Service (SMS), menu guides, games (e.g., on-line games) and email.

The campaign management module 106 can allow a user 102 to manage various advertisement functions, including but not limited to, contract activities, campaign activities, and advertisement activities. These activities, can include but are not limited to, viewing, creating, editing, deactivating, activating, and deleting, an advertisement contract, advertisement campaign, and/or advertisements, as well as previewing advertisements and viewing targeting options for an advertisement campaign. Advertisements can be created outside of the system and uploaded to the system 100 via the campaign management module 106. Prior to uploading an advertisement to the system, 100, the advertisement can be reviewed to ensure the advertisement meets system requirements as well as content criteria. Guidelines, such as Internet Advertisement Bureau (IAB) guidelines, can be provided to the users 102 in order to assist in making system compliant advertisements.

The campaign management module 106 can be integrated with various vendor subsystems to provide targeted advertisements. For example, a vendor subsystem, such as SEACHANGE™ by SeaChange International of Acton, Massachusetts, can be used to splice advertisements into a Video on Demand (VOD). In another example, a vendor subsystem, such as TERAYON™ DM6400 by Terayon Communications Systems of Santa Clara, Calif., can be used to provide interactive advertisements, linear advertisements and banner advertisements for set top box (STB) games, fantasy sport websites, menu guides, etc. Additional or other vendor subsystems may also be used to deliver advertisements to one or more targeted consumer devices 114, 116, 118, 120.

The campaign management module 106 can receive impression and conversion data for billing purposes. Specifically, the campaign management module 106 can gather the number of potential consumers 122 who view a targeted advertisement, and/or the number of potential consumers who click through, interact, bookmark, generate a request for information (RFI), or otherwise take action based on a targeted advertisement. Based on the potential consumer interaction, the campaign management module 106 can gather the information relating to the potential customer's interactions with respect to the targeted advertisement and the user 102 can be charged based on the actual viewing of the targeted advertisement. Thus, the users 102, e.g., owners, marketers, advertisement personnel, can be charged for targeted advertisements that they know one or more potential consumers 122 have shown an interest in viewing. The campaign management module 106 can gather the number of times a targeted advertisement or a link for a targeted advertisement was displayed to potential consumers 122, but was not acted upon by the potential consumers, e.g., a link to a targeted advertisement video was not acted upon. This information can be provided to a user 102, thus providing a metric for the user 102 as to the effectiveness of a targeted advertisement or link to a targeted advertisement.

A targeting system module 108 can schedule the launch of a targeted advertisement campaign through targeted consumer devices for delivery to a targeted demographic audience. The targeting system module 108 can use historical, psychological, and behavioral information from one or more sources and profiles to determine appropriate targeted advertisements to be delivered on one or more types of consumer devices 114, 116, 118, 120. For example, a targeted advertisement can be directed at a specific target group, based on, but not limited to, one or more of the following: house hold targeting, geographical location (e.g., based on zip code), demographic (e.g., age, income, sex, etc.), psychographic (behavioral), and location based on the location of a mobile device 120 (e.g., via a global positioning system (GPS) in the phone or triangulation techniques). The delivery of the targeted advertisements can be in response to a triggering event. A triggering event can be a scheduled advertisements or in response to a potential consumer's activity. A scheduled advertisement can be a targeted advertisement sent at a specified time. A potential consumer's activity can be the next time the potential consumer accesses the Internet or email, when a consumer device 114, 116, 118, 120 is turned on, and/or when a Video on Demand (VOD) is ordered.

A decision support module 112 can include applications for reporting, tracking, and providing feedback to the targeting system module 108. The feedback can be based on metrics regarding effectiveness of a targeted advertisement campaign. The decision support module 112 can receive impression and conversion data for metric purposes. Specifically, the decision support module 112 can gather the number of potential consumers 122 who view a targeted advertisement, and/or the number of potential consumers who click through, interact, bookmark, generate a request for information (RFI), or otherwise take action based on a targeted advertisement. Based on the potential consumer interaction, the decision support module 112 can gather information relating to the potential customer's interactions with respect to the targeted advertisement. The decision support module 112 can gather the number of times a targeted advertisement or a link for a targeted advertisement was displayed to potential consumers 122, but was not acted upon by the potential consumers, e.g., a link to a targeted advertisement video was not acted upon. This information can be provided to a user 102, thus providing a metric for the user 102 as to the effectiveness of a targeted advertisement or link to a targeted advertisement.

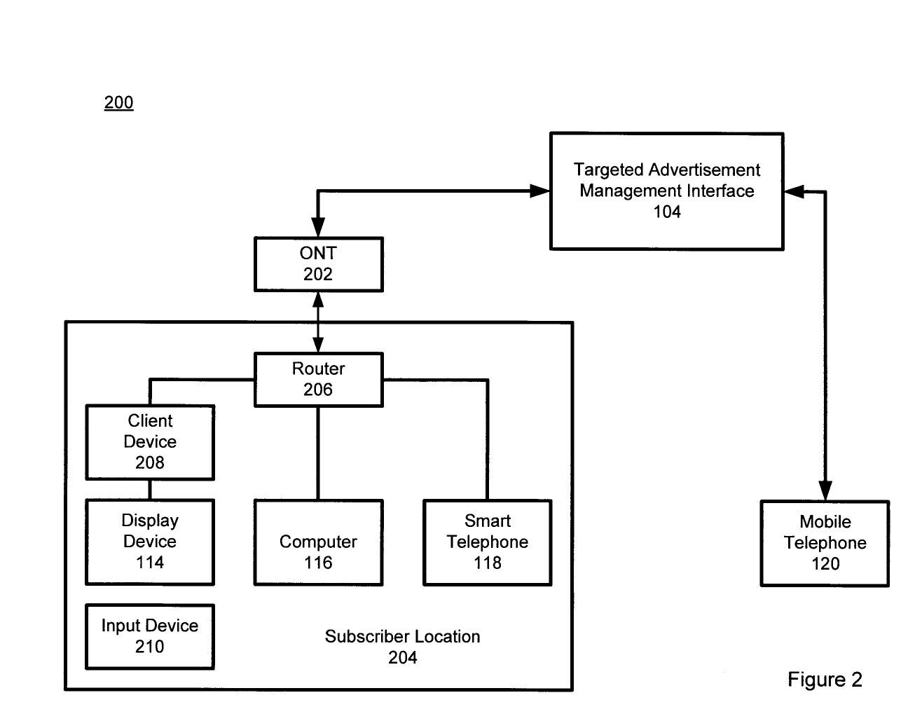

Referring to FIG. 2, a targeted advertisement delivery system in accordance with an exemplary embodiment is illustrated. It should be appreciated that the system shown in FIG. 2 is a simplified view of a targeted advertisement delivery system 100 and may include additional elements that are not depicted. The targeted advertisement delivery system 200 can be interposed between consumer devices 114, 116, 118, 120 and service providers, e.g., television, Internet, and telephone service providers (not shown). Alternatively, the targeted advertisement delivery system 200 can be part of or communicatively coupled to one or more service providers. The targeted advertisement management interface 102 can provide advertisement signals to one or more consumer devices 114, 116, 118, 120. The advertisement signals can be signals for causing display of video, audio, text, or a combination thereof, on the consumer devices 114, 116, 118, 120.

In various exemplary embodiments, the targeted advertisement management interface 104 can communicate using a passive optical network (not shown). In the illustrated exemplary embodiment, the targeted advertisement management interface 104 can communicate optical signals to an optical networking termination (ONT) 202 at or near a subscriber location 204. The optical signals can include digital data. The passive optical network can, for example, comply with the International Telecommunication Union Telecommunication Standard (ITU-T) Recommendation G.983.1 titled “Broadband Optical Access Systems based on Passive Optical Networks (PON),” January 2005, the contents of which are incorporated herein by reference in its entirety. Downstream digital data optical signals transmitted from the targeted advertisement management interface 104 to the optical networking termination (ONT) 202 can use a 1490 nanometer (nm) wavelength. A radio frequency optical video signal transmitted from the targeted advertisement management interface 104 to the optical networking termination (ONT) 202 can use a 1550 nanometer (nm) wavelength. Upstream digital data optical signals transmitted from the optical networking termination (ONT) 202 to the targeted advertisement management interface 104 can use a 1310 nanometer (nm) wavelength. The radio frequency optical video signal can comply with the American National Standard Society of Cable Telecommunication Engineers standard ANSI/SCTE 07 2006 titled “Digital Transmission Standard for Cable Television,” the contents of which are incorporated herein by reference in its entirety. Other optical and non-optical communication systems, networks, and standards also can be used.

Although FIG. 2 illustrates an optical network between the targeted advertisement management interface 104 and the optical networking termination (ONT) 202, other networks instead of or in addition to an optical network also can be used, e.g., non-optical networks, and/or cable networks, wireless networks, etc. For example, the advertisement signals can be sixty-four (64) point signal constellation Quadrature Amplitude Modulation (QAM) digital cable signals (QAM64), two-hundred-fifty-six (256) point signal constellation QAM digital cable signals (QAM256), cable signals in other analog or digital cable television formats, as are well known.

The optical networking termination (ONT) 202 can provide the optical signals to the subscriber location 204. For example, the optical networking termination (ONT) 202 can convert the radio frequency optical video signal and the downstream digital data optical signals to electrical radio frequency signals for transmission via coaxial wiring of the subscriber location 204. The subscriber location 204 also can include optical fiber instead of coaxial wiring and therefore does not need an optical to electrical conversion.

A router 206 can receive and forward the advertisement signals to one or more consumer devices 114, 116, 118. For example, the router 206 can provide the advertisement signals to a client device 208 which can be communicatively coupled to an Ethernet port of the router 206 (e.g., through cables or wireless connection). Optionally, the router 206 can be omitted and the consumer device 114, 116, 118 can be coupled to the optical networking termination (ONT) 202 and a multimedia over coaxial (MOCA) cable technology can be used for data communication.

In some embodiments, a client device 208 can process and/or convert the advertisement signals for display at a display device 114 to a viewer. The client device 208 can be a set top box (STB). The display device 114 can be a television set. The display device 114 also can be other devices capable of displaying video, such as, but not limited to, a computer monitor. The client device 208 and the display device 114 also can be a single device, instead of two separate devices, as shown. The display device 114 can have an associated input device 210. The input device 210 can be, for example, a remote control, a keyboard, or other device that can receive and communicate input from a viewer. The input device 210 also can be integrated with the client device 208 and/or the display device 114.

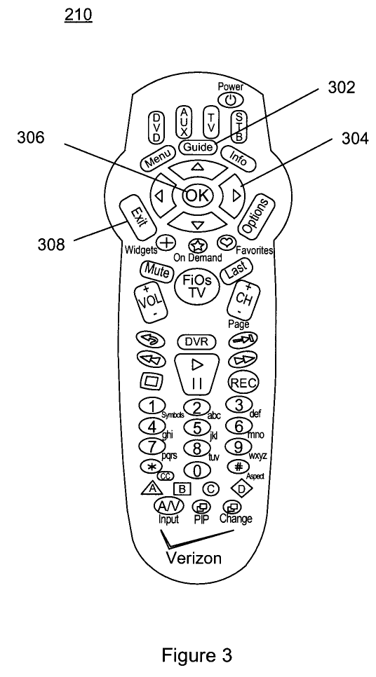

Referring to FIG. 3, an input device 210 in accordance with an exemplary embodiment is illustrated. A potential consumer 122 can use the input device 210 to generate commands to control the client device 208. The commands can be, for example, a display graphical user interface command 302, one or more navigation commands 304, a selection command 306, and an exit command 308. The exit command 308 can communicate a termination identifier to exit out of a display of a graphical user interface, the display graphical user interface command 302 can instruct the client device 208 to cause the display of a graphical user interface, the one or more navigation commands 304 can be arrows for scrolling through and highlighting various fields of a graphical user interface, and the selection command 306 can select a particular field within the graphical user interface. It is noted that the input device 210 is depicted as being a remote control with keys that can be pressed by a user. The input device 210 also can include a touch screen where the viewer can touch an icon on a display (e.g., on display device 114). Other input devices also can be used, such as, but not limited to, voice activated or gesture activated input devices. The input device 210 can be used to allow a potential customer 122 to navigate through a targeted advertisement, such as an interactive advertisement in a menu guide.

Returning to FIG. 2, the client device 208 can establish a video communication session for receiving advertisement signals from the targeted advertisement management interface 104 and can establish a data communication session for communicating with the targeted advertisement management interface 104. The video communication session can communicate video advertisement signals in an analog and/or digital format. For example, the video communication session can transport radio frequency QAM64 formatted digital cable signals, QAM256 formatted digital cable signals, or can transport cable signals in other analog or digital cable television formats, as are well known. The video communication session also can transport digitized video in packets, cells, or other data types. For example, the video communication session can be an Internet Protocol (IP) channel for exchanging Internet Protocol (IP) packets. The video communication session can be used to permit the client device 208 and targeted advertisement management interface 104 to display targeted advertisements on the display device 114, as will be discussed in further detail below. The viewer can, using an input device 210, select to view a targeted advertisement by communicating a selection request signal to the client device 208 to tune to a particular channel broadcast by the targeted advertisement management interface 104.

In some embodiments, the router 206 can receive and forward the advertisement signals to a computer 116 and/or a smart telephone 118. The computer 116 and/or smart telephone can convert the advertisement signals and can cause the targeted advertisement to be displayed on the computer 116 and/or the smart telephone 118. The computer 116 and/or smart telephone 118 can receive and forward input signals from the potential consumer 122. For example, a potential consumer 122 can use a keyboard, mouse, and/or touchscreen associated with the computer 116 or can use a keyboard and/or touchscreen associated with the smart telephone 118 to generate input signals which are sent to the targeted advertisement management interface 104.

Advertisement signals can be provided to a mobile device 120 associated with a potential consumer 122. For example, the targeted advertisement management interface 104 can send one or more advertisement signals to a mobile device 120 using one or more networks as is well known. The mobile device 120 can receive and forward input signals from the user. For example, a user can use a keyboard and/or touch screen associated with the mobile device 120 to generate input signals which are sent to the targeted advertisement management interface 104.

The advertisement signals can include advertisements which can take various forms, including, but not limited to, interactive advertisements, banner advertisements, Video on Demand (VOD) advertisements, bumper advertisements, and addressable advertisements. An interactive advertisement can refer to an advertisement in which a potential consumer 122 can enter an input signal, e.g., click on the displayed advertisement, to receive additional information, e.g., a longer advertisement. Typically, an interactive advertisement includes content, a trigger, and a return path for user interaction. Interactive advertisements can be overlayed over content and/or an advertisement. A banner advertisement can refer to an advertisement that is displayed in a section of the display, but not the entire display. A Video on Demand (VOD) advertisement can refer to an advertisement that is displayed before, during, or after a Video on Demand (VOD). A bumper advertisement can refer to an advertisement that is played at the beginning or end of a Video on Demand (VOD). A bumper advertisement is typically part of the Video on Demand (VOD) content. An addressable advertisement can refer to an advertisement that is displayed to a group of viewers based on user profile information, e.g., information associated with the viewers such as location, interests, etc. The addressable advertisement can be used with broadcasts, IP multicasts, and/or unicast video streams.

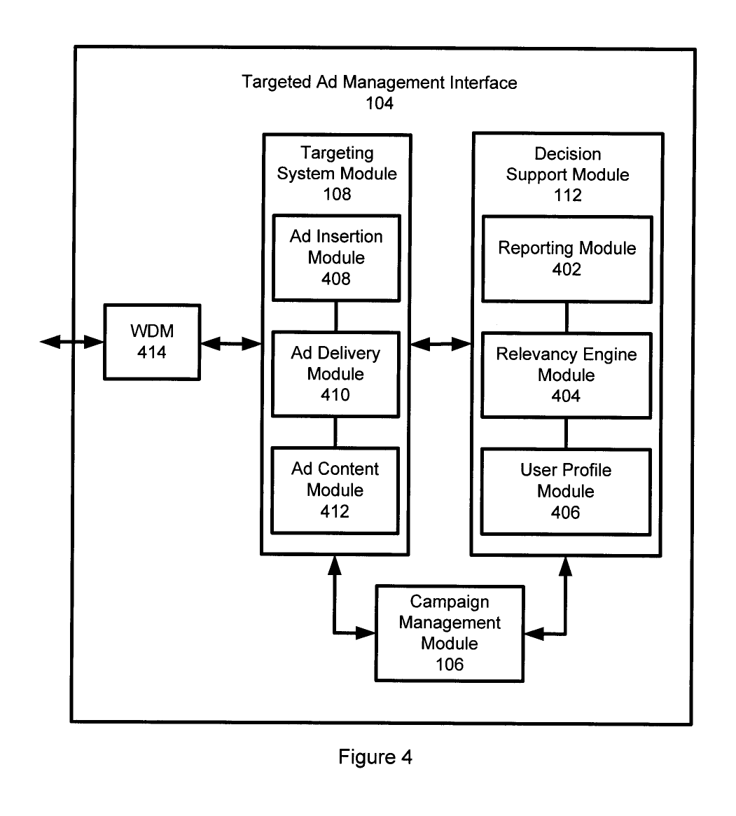

Referring to FIG. 4, a block diagram of the targeted advertisement management interface is illustrated. As shown, the targeted advertisement management interface 104 can include the campaign management module 106, the targeting system module 108, and the decision support module 112. The campaign management module 106 can interact with the users 102. For example, the campaign management module 106 can provide a graphical user interface (GUI) (not shown) for interacting with the users 102. Using the GUI, the user 102 can launch new campaigns, add advertisements, and set budgets and rules for each campaign. Using the campaign management module 106, the users 102 can upload advertisements. The campaign management module 106 allows a user 102 to interact with the targeted advertisement management interface 104 which can allow a user 102 to create and manage advertisement campaigns. When creating or editing an advertisement campaign, the user 102 can select target profiles in order to determine the potential consumers 122 to display a targeted advertisement.

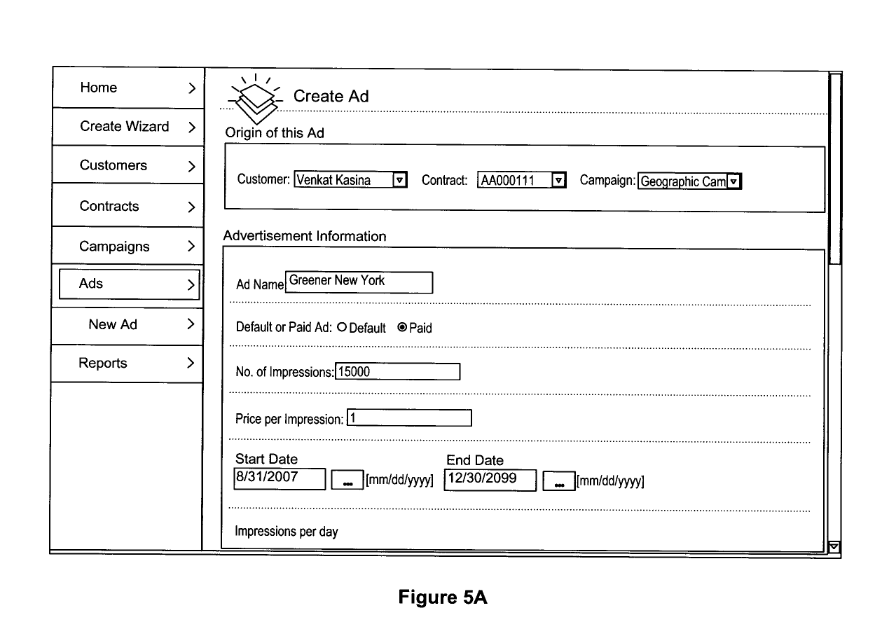

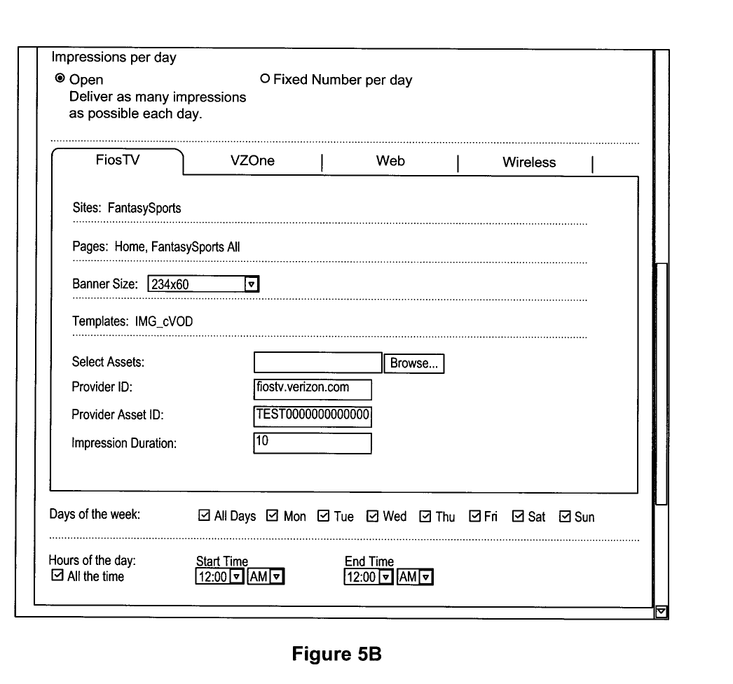

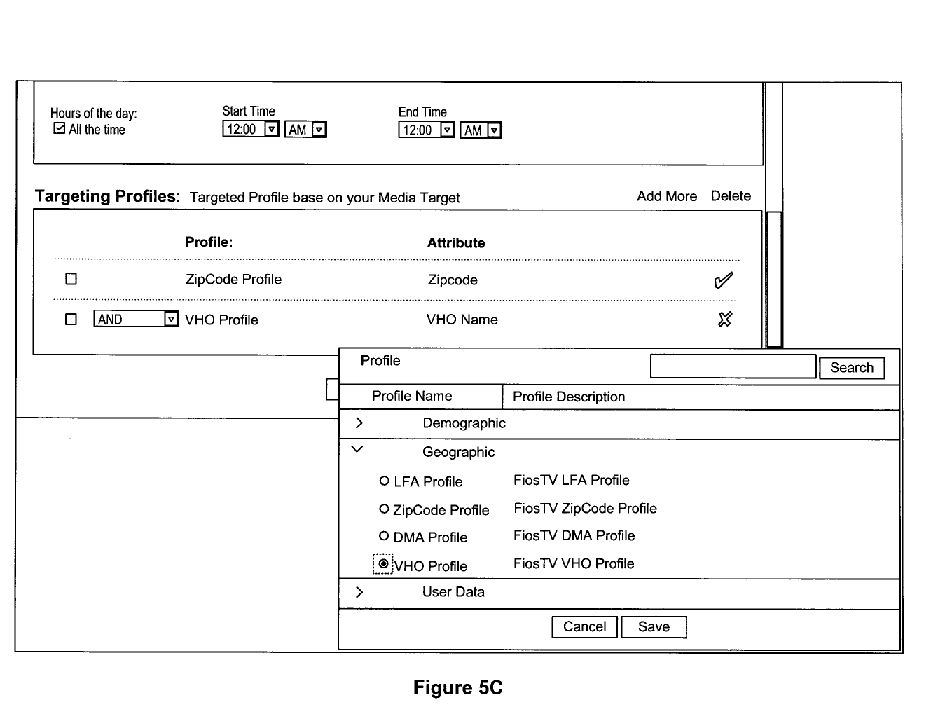

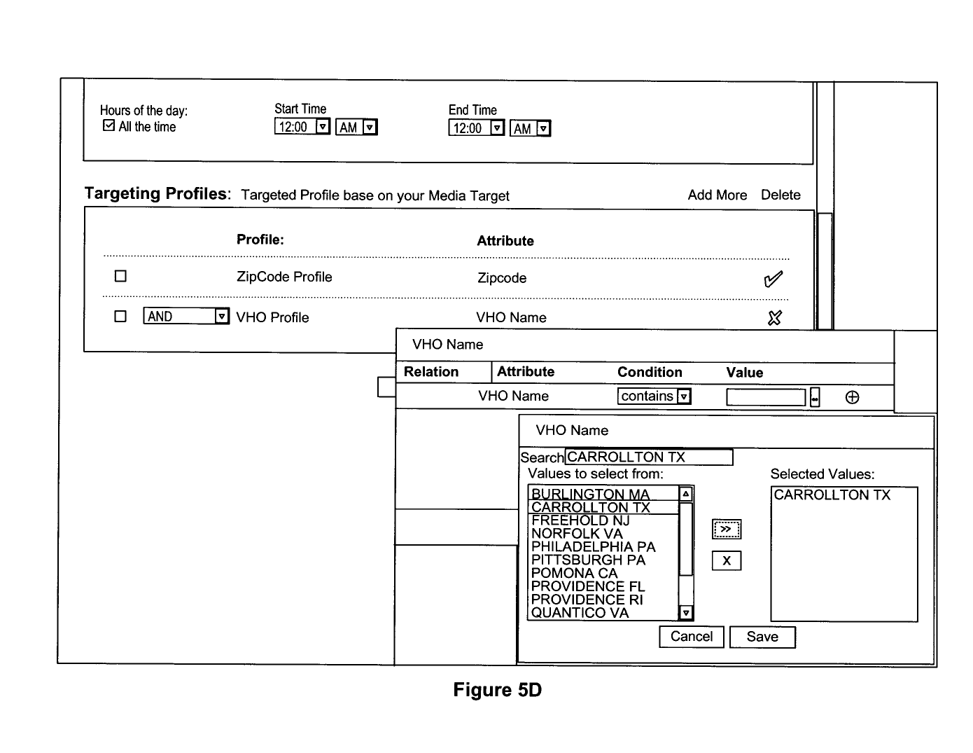

Referring to FIGS. 5A-5E, exemplary screenshots for creating an advertisement in accordance with an exemplary embodiment are illustrated. As shown in FIG. 5A, a user 102 can identify the origin of an advertisement and advertisement information. For example, the origin of an advertisement can include prompts for the user to identify the customer, contract and type of campaign by selecting by selecting the appropriate selection from drop down menus. The customer is in this example can be one of the users 102, e.g., advertisers or business owners. The contract can be the contract that the advertisement campaign will fall under. The campaign can be the type of campaign, which can be based on one or more of the following: house hold targeting, geographical location (e.g., based on zip code), demographic (e.g., age, income, sex, etc.), psychographic (behavioral), and location based on the location of a mobile device 120 (e.g., via a global positioning system (GPS) in the phone or triangulation techniques). The advertisement information can be the advertisement name, payment (e.g., default or paid), number of impressions for the advertisement, price per impression, start date and end date of the advertisement campaign. An impression can be each instance that the advertisement is displayed, e.g., each time a banner advertisement is displayed to a potential consumer 122.

Referring to FIG. 5B, an exemplary screenshot for entering the number of impressions for a day, which targeted devices, days of the week, and hours of the day is illustrated. As shown, the user 102 can be prompted to select the impressions per day which can be open (deliver as many impressions as possible per day) or a fixed number per day. For each user device, e.g., television (Fios TV), smart phone (Verizon One), web, and wireless devices (mobile devices), the user is prompted to enter information for the advertisement for that particular device. As shown, the user 102 is prompted to select the banner size advertisement for a FiosTV advertisement that is to be displayed on all of the fantasy sports pages. The user is also prompted to enter Select Assets, Provider ID, Provider Asset ID, and Impression Duration. The select asset can be the specific banner advertisement that is stored in the system. The provider ID can be the identification of the provider, e.g., customer id, and the provider assert ID can be an advertisement identifier, e.g., product id. The impression duration can be the length of time the impression is displayed, e.g., the banner advertisement will be displayed for ten minutes. The user can be prompted to enter the days of the week and hours of the day that the advertisement should be displayed. For example, the banner advertisement can be displayed twenty-four hours a day, seven days a week.

Referring to FIG. 5C, an exemplary screenshot for selecting the targeting profiles based on the media target is illustrated. As shown, the top window prompts the user 102 to select a targeting profile from demographic, geographical, and user data target profiles. In this example, the geographical target profile is selected and includes a local franchise area (LFA) profile, zip code profile (e.g., based on potential consumer's zip code), direct marketing area (DMA) profile, and Video Head Office (VHO) profile (e.g., based on the name of the VHO, the television market). As shown, the VHO profile is selected. The user is prompted to save or cancel the selection. The bottom window displays the target profiles the user 102 has selected.

Referring to FIG. 5D, an exemplary screenshot of target profiles for VHO profiles is illustrated. As shown, the user 102 is prompted to select one or more VHO names (e.g., television markets) as part of the target profiles. In this example, the user 102 has selected the Carrollton, Tex. VHO. As shown, the user is prompted to either cancel or save the target profiles that the user 102 selected.

The selected target profiles provide the rules that the targeting system module 108 to determine which targeted advertisements are displayed to which potential consumer 122. For example, using the exemplary screenshots above, the user 102 was creating an advertisement campaign to send a banner advertisement to potential consumers 122 that received their television signals from the Carrollton, Tex. VHO. The user 102 could have also selected additional target profiles, such as demographic profiles which could have further refined the targeted potential consumers 122, e.g., to males under the age of 40 years of age having an income over $100,000.

Referring to FIG. 4 again, the decision support module 112 can include a reporting module 402, a relevancy engine module 404, and a user profile module 406. The reporting module 402 can generate reports, record usage metrics, and store metric data. For example, the reporting module 402 can record the number of impressions and clicks which can be provided to a billing system. The results of the reports can be provided to the relevancy engine module 404 for performing business analytics to discover more about how customers and potential customers behave.

A relevancy engine module 404 can be used to assist in identifying a targeted demographic audience. The relevancy engine module 404 can segment potential consumers 122 and associated consumer devices 114, 116, 118. 120 based on the gathered data. Segments can represent logical groups of potential consumers who share similar characteristics or behavior. The data can be used to generate statistical modeling using algorithms, e.g., collaborative filtering algorithms, and the results of the analysis can be provided to the targeting system module 108 to assist in making marketing decisions.

The relevancy engine module 404 can also include a scheduling module (not shown). The scheduling module can determine when and to who advertisements are provided to based on rules, e.g., based on the target profiles, and the consumer devices 114, 116, 118, 120. The scheduling module can also group different advertisements together into one or more advertisement campaigns with each campaign having its own set of rules. In selecting targeted advertisements, the relevancy engine module 404 can include other factors in the selection process. For example, weighting factors based at least on part with the total number of impressions for an advertisement campaign and the total number of impressions to date. Thus, if there are two suitable targeted advertisements that can be sent, one targeted advertisement may have a higher weighting factor because that advertisement campaign has 100 more impressions for that day and the other targeted advertisement has only 1 more impression for that day. The scheduling module can be located separately or with other modules. For example, the scheduling module can be part of the campaign management module 106 or with the targeting system module 108.

The user profile module 406 can maintain user profiles associated with the potential consumers 122 of the consumer devices 114, 116, 118, 120. For example, a user profile can include, but is not limited to, a user's name, address, home telephone number, work telephone number, mobile telephone number, email address, date of birth, income, sex, education, place of work, set-top box address (or identification information), behavior patterns, current location, etc. The user profile can receive data from various sources, including but not limited to, client device 208 (e.g., set top box), computer 116, smart telephone 118, and mobile telephone 120. The consumer devices 114, 116, 118, 120 and client devices 208 can maintain local user profiles at the consumer devices 114, 116, 118, 120 and client devices 208 can be updated by the relevancy engine module 404. The relevancy engine module 404 can update the local user profiles with information from the user profile module 406 on a periodic basis or upon use of the device where the updated information can come from a user's interactions using other consumer devices, e.g., computer 116, smart telephone 118, and/or mobile telephone 120. For example, a client device 208, such as a set top box, can maintain a profile for one or more users who are associated with the client device 208.

The targeting system module 108 can include an advertisement insertion module 408, advertisement delivery module 410, and advertisement content module 412. In an exemplary embodiment, the advertisement insertion module 408, advertisement delivery module 410 and advertisement content module 412 can be housed at a video head office (VHO) or a video service office (VSO) and can splice advertisements into video streams. For example, a regional VHO can duplicate popular channels and insert geographical (local) targeted advertisements, into the video stream. The advertisement insertion module 408 can insert targeted advertisements based on the relevancy of the advertisement, media, and consumer device. The advertisement insertion module 408 can insert targeted advertisements, local or national, into the service being provided to a potential consumer 122. For example, the advertisement insertion module 408 can use SCTE-35 digital splicing cueing message and industrial standard protocols, e.g., SCTE-30 to provide interactive advertisements to a user/targeted group 122.

In some embodiments, the client device 208 can insert an advertisement into a video stream. For example, a set top box 208 can receive instructions from the advertisement insertion module 408 to splice a targeted advertisement based on the local profile into a video stream, e.g., replace an existing commercial. The set top box 208 can receive or download and store targeted advertisements and display them in response to a triggering event, e.g., a commercial break. In other embodiment, the set top box 208 can receive a command (e.g., from the advertisement insertion module 408) to switch to an alternate advertisement stream at a specified time. For example, the set top box 208 can switch from a linear broadcast channel over QAM to an Internet Protocol (IP) video stream to display an IP broadcast/multicast targeted advertisement and then switches back to the linear broadcast channel after displaying the targeted advertisement. Switching to the Internet Protocol (IP) video stream can include the set top box 208 choosing an appropriate medium, such as, but not limited to, a unicast video on demand, mean regional digital video recorder (MDVR) stream from a local storage source or an Internet Protocol (IP) multicast stream depending on availability of technology and resources. Similarly, the set top box 208 can switch from a linear broadcast to a targeted advertisement on a video on demand channel and back to the linear broadcast.

The advertisement delivery module 410 is configured to provide targeted advertisements to one or more consumer devices 114, 116, 118, 120 associated with a potential consumer 122, e.g., client device 208, computer 116, smart telephone 118, and/or mobile device 120. For example, targeted advertisements can be in HyperText Markup Language (HTML), text, images, media, video over Hypertext Transfer Protocol (HTTP), User Datagram Protocol (UDP), Real Time Streaming Protocol (RTSP), Multimedia Messaging Service (MMS) and other formats and protocols that can provide advertisement to consumer devices 208, 116, 118, 120. The advertisement content module 412 can store targeted advertisements in various formats using several protocols. For example, the user 102 can create multiple targeted advertisements in one or more formats using one or more protocols. In addition, the advertisements can be transcoded so that the advertisements can be provided to consumer devices, 114, 116, 118, 120 based on the capabilities of the consumer devices 114, 116, 118, 120. For example, the user 102 can create one or more targeted advertisements in one or more formats using one or more protocols, and the created targeted advertisement can be transcoded into a suitable format and protocol based on a targeted consumer device 114, 116, 118, 120 using transcoding systems and/or software as known in the art. In this example, the advertisement insertion module 408 can perform the transcoding of the targeted advertisement.

An insertion/extraction point 414 can insert targeted advertisement from the targeting system module 108 into the downstream video signals for transmission to the optical networking termination (ONT) 202 and extract upstream responses for transmission to the targeted advertisement management interface 104. The insertion/extraction point 414 may include one or more elements, such as Optical Line terminals (OLTs), and may include facilities to perform wavelength division multiplexing (WDM) to deliver signals appropriately over the PON frequencies—e.g., downstream content over the 1490 nm wavelength and the 1550 nm wavelength and upstream content over the 1210 nm wavelength band.

The reporting module 402 can generate a metrics report to inform users 102 about the potential consumers 122 who have selected to view a targeted advertisement. The metrics report can identify an aggregate number of viewers who have selected to view advertisements and also can identify the geographic locations of these viewers. The metrics report can be generated electronically or in a physical form. In an exemplary embodiment, the metrics report can indicate a number of views of a targeted advertisement, charges associated with the number of views, and a number of viewers by viewer location information. The number of views of the targeted advertisement can indicate a total number of how many times the advertisement was sent to one or more consumer devices 114, 116, 118, 120. The number of viewers by viewer location information can indicate the different geographic locations (e.g., by street, by zip code, by city, by state, by region, by country, etc.) of the viewers requesting to access the targeted advertisement. Thus, the metrics report can provide the users 102 with meaningful information about their potential consumers 122.

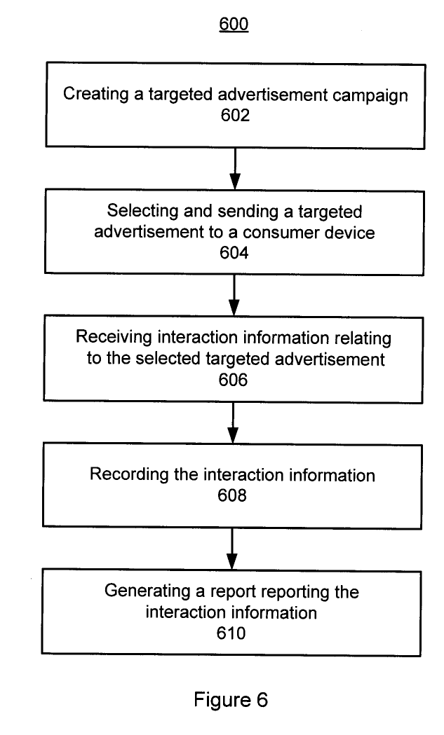

FIG. 6 illustrates a flow diagram of a method in accordance with exemplary embodiments. This exemplary method is provided by way of example, as there are a variety of ways to carry out methods. The method shown in FIG. 6 can be executed or otherwise performed by one or a combination of various systems. The method is described below as carried out by the system 100 shown in FIG. 1 by way of example, and various elements of the system 100 are referenced in explaining the example method of FIG. 6. Each block shown in FIG. 6 represents one or more processes, methods or subroutines carried in the exemplary method.

In block 602, the method 600 can include creating a targeted advertisement campaign. For example, a user 102 can access the targeted advertisement management interface 104 via a network, such as, but not limited to the Internet, and create a targeted advertisement campaign. The user 102 can use the targeted advertisement management interface 104 which can include a graphical user interface (GUI) and associated tools to create targeted advertisement campaigns. Targeted advertisement can be uploaded to the targeted advertisement management interface 104. For example, the uploaded targeted advertisement can be stored in the advertisement content module 412. The targeted advertisement can be in a single format, multiple formats, or can be transcoded in multiple formats, where a format is in compliance with a protocol and/or method used in delivering the targeted advertisement. Using the targeted advertisement management module 104, the user 102 can select one or more target profiles for whom the targeted advertisement management interface 104 can direct the targeted advertisements. The entered information can include one or more rules for assisting the targeted advertisement management interface 104 in directing targeted advertisements. After creating a targeted advertisement campaign, the method 600 can proceed to block 604.

In block 604, in response to a triggering event, the targeted advertisement management interface 104 can select and send a targeted advertisement to a consumer device 114, 116, 118, 120. The triggering event can be a potential consumer 122 accessing a consumer device 114, 116, 118, 120, such as turning on a display device 114, ordering a video (e.g., via a Video on Demand (VOD) system), accessing the Internet or a specific website via a computer 116, smart telephone 118 or mobile device 120, or turning on a mobile device 118, such as a cellular telephone or personal digital assistant (PDA), or a scheduled event (for example, sending an email message or text message to a consumer device 116, 118, 120 at a specified time). The targeted advertisement management interface 104 can access a profile (e.g., a user profile stored in the user profile module 406 or a local profile such as a profile stored in a set top box 208) and determine a suitable targeted advertisement for the potential consumer 122. For example, the relevancy engine module 404 can use information from the profile and the rules associated with one or more targeted advertisements to determine a suitable targeted advertisement to provide to the consumer device 114, 116, 118, 120 associated with the potential consumer 122. The relevancy engine module 404 can provide instructions to the advertisement delivery module 410 to provide the selected targeted advertisement to the consumer device 114, 116, 118, 120. The advertisement delivery module 410 can acquire the selected targeted advertisement from the advertisement content module 412. If needed, the advertisement insertion module 408 can insert the selected targeted advertisement into the content being provided to the consumer device 114, 116, 118, 120. For a selected targeted advertisement being provided to a display device 114 via a client device 208, the client device 208 can insert the selected targeted advertisement into the content being provided to the display device 114. The selected targeted advertisement can be converted to a suitable format or can be in a suitable format. The targeted advertisement management interface 104 can provide the targeted advertisement in a suitable format to a targeted consumer device 114, 116, 118, 120. In some embodiments, the selected targeted advertisement can be a link to the advertisement which can prompt a potential consumer 122 to click on the link for the full advertisement, e.g., an interactive advertisement. After providing the selected targeted advertisement to a consumer device, 114, 116, 118, 120, the method 600 can proceed to block 606.

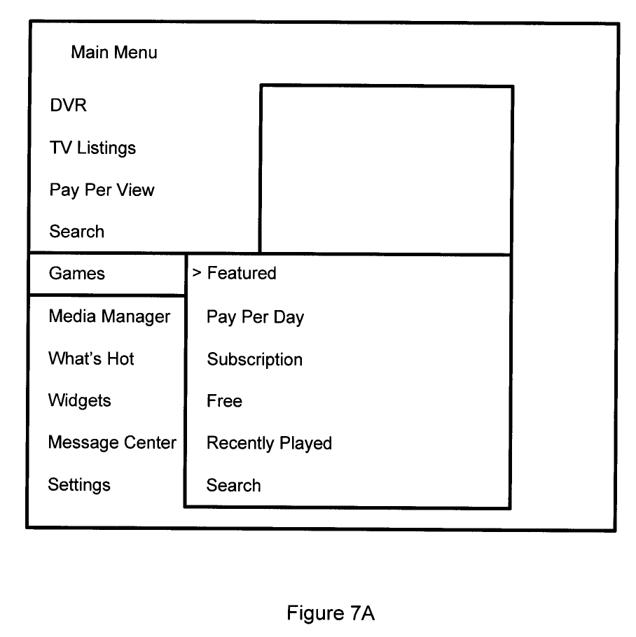

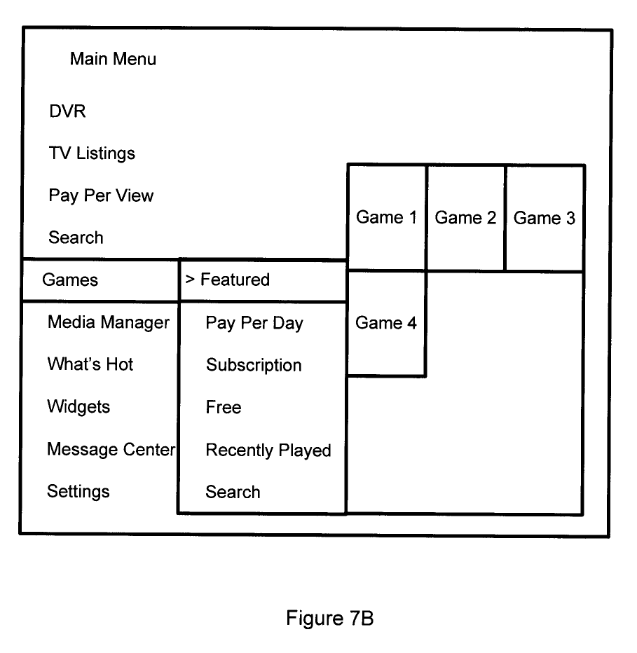

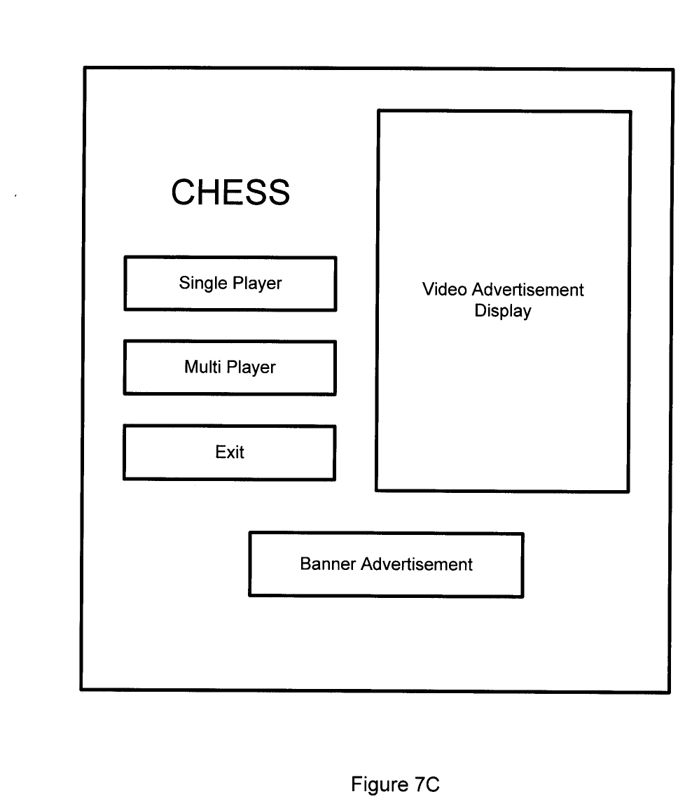

Referring to FIGS. 7A-7C, exemplary block diagram of screen layouts of a target advertisement insertion for an on-line television game in accordance with exemplary embodiments are illustrated. FIG. 7A depicts an exemplary screenshot of a main menu guide (for a television) providing a user with multiple viewing options. A television program for the currently selected channel can be displayed, e.g., in the top right corner. The menu can include options for digital video recorder (DVR), television listings, pay per view, search, games, media manager, what's hot, widgets, message center, and settings. As shown, the games option is selected with a dropdown menu with additional options under games. For example, the game options include featured, pay per day, subscription, free, recently played, and search. The featured option is selected is highlighted, but not selected. The featured games can be the newest games the service provider is offering.

FIG. 7B depicts an exemplary screenshot of a selected “Featured” option from the main menu guide. Using a remote control, a potential consumer 122 could have selected the “Featured” option. As a result of the selection, the featured option lists four “featured” games: game 1-4. Using the remote control again, the potential consumer 122 can select one of the four featured games.

FIG. 7C illustrates an exemplary screenshot of a selected game. For example, after the potential consumer 122 selects a featured game, e.g., chess, from the featured options list, a new screen for the chess game is presented. The user is presented with three game options, single player, multi player, and exit. In addition, a targeted banner advertisement can also be displayed for the potential consumer 122. The targeted banner advertisement can be a targeted advertisement that the targeting system module 108 selected based on a profile associated with the potential consumer 122 and the rules associated with various advertisements. The targeted banner advertisement can be replaced with one or more other targeted banner advertisements with each being displayed for a set time. One or more of the targeted banner advertisements can include a link for a targeted video advertisement. If the link is selected, the targeted video advertisement can be displayed next to the game.

Returning to FIG. 6, in block 606, the campaign management module 106 receives information relating to potential consumer interaction with the selected targeted advertisement. For example, the consumer device 114, 116, 118, 120 provides the campaign management module 106 information relating to whether the potential consumer 122 responded to the selected targeted advertisement. The response can include, but is not limited to the potential consumer 122 watching or clicking through the selected targeted advertisement, if the potential consumer 122 creates a bookmark associated with the selected targeted advertisement, if a request for more information (RFI) was generated or other information whether the potential consumer 122 responded to the selected targeted advertisement. After receiving information related to the selected targeted advertisement, the method 600 can proceed to block 608.

In block 608, the campaign management module 106 records the potential consumer interaction. For example, the campaign management module 106 can record the number of potential consumers 122 who responded to the selected targeted advertisement. After recording potential consumer interaction, the method 600 can proceed to block 610.

In block 610, the targeted advertisement interface 104 can generate a report. For example, the reporting module 112 can generate a report for a user 102 with the report reporting on the demographics associated with the potential consumers 122 who responded to the selected targeted advertisement. The report can include information regarding the demographics of the potential consumers 122 who received the selected targeted advertisement (but did not respond to the selected targeted advertisement) as well the potential consumers 122 who responded to the selected targeted advertisement, thereby allowing the user 102 to modify the rules relating to the potential consumers 122 for the targeted advertisement campaign. For example, the user 102 can use the targeted advertisement user interface 102 to edit the selected target profiles based on the information in the report.

In block 610, the targeted advertisement management interface 104 can tally the number of potential consumers who received the selected targeted advertisement as well as the number of potential consumers who responded to the selected targeted advertisement for billing purposes. Thus, the user 102 can be billed for either tally. For example, a user 102 can only be billed for selected targeted advertisements in which potential consumers 122 responded to the selected targeted advertisement. In this example, the user 102 is only charged for selected targeted advertisements in which the consumer responded verses traditional advertisements where the user 102 is charged for each instance in which an advertisement was promoted, e.g., aired, displayed, printed, etc.

In the preceding specification, various preferred embodiments have been described with reference to the accompanying drawings. It will, however, be evident that various modifications and changes can be made thereto, and additional embodiments can be implemented, without departing from the broader scope of the invention as set forth in the claims that follow. The specification and drawings are accordingly to be regarded in an illustrative rather than restrictive sense.

1. A system comprising:
a campaign management component configured to manage targeted advertisements for multiple types of targeted consumer devices and to manage associated targeted advertisement campaigns;
a targeting component configured to send a targeted advertisement to at least one targeted consumer device over a network, wherein the targeted advertisement is associated with a targeted advertisement campaign and is based at least on part of at least one profile associated with at least one targeted consumer device and rules associated with the targeted advertisement campaign; and
a decision component configured to receive, from the at least one targeted consumer device, receptiveness data associated with the targeted advertisement.

2. The system of claim 1 wherein the campaign management component is configured to cause the prompting of a user for target group information and to receive the target group information, wherein the target group information includes at least one of household, geographical, demographic, psychographic, and location information.

3. The system of claim 2 wherein the rules associated with the targeted advertisement campaign are derived from the target group information.

4. The system of claim 1 wherein the targeting component is configured to cause the insertion of a targeted advertisement into one of a banner advertisement on a webpage, video on demand, interactive advertisement on a webpage, short message service (SMS) messages, and email messages.

5. The system of claim 1 wherein the targeting component is configured to cause an insertion of a targeted advertisement into a video stream.

6. The system of claim 5 wherein the insertion of the targeted advertisement occurs at one of a video head office, a video service office, and a client device.

7. The system of claim 1 wherein the targeting component module causes a signal to be sent to a client device causing the client device to switch from receiving a broadcast over a linear broadcast channel to a targeted advertisement on a video on demand channel.

8. The system of claim 1 wherein the targeting component module causes a signal to be sent to a client device causing the client device to switch from receiving a broadcast over a linear broadcast channel to a targeted advertisement on a Internet Protocol (IP) channel.

9. The system of claim 1 wherein the receptiveness data includes at least one of a selection to watch a targeted advertisement, a request to create a bookmark for an associated target advertisement, a request for more information associated with a targeted advertisement.

10. The system of claim 1 wherein the targeted consumer device comprises at least one of a client device, mobile telephone, smart telephone, personal digital assistant, and a computer.

11. A method comprising:
entering a targeted advertisement for multiple types of targeted consumer devices;
sending the targeted advertisement to at least one targeted consumer device over a network, wherein the targeted advertisement is associated with a targeted advertisement campaign and is based at least on part of at least one profile associated with at least one targeted consumer device and rules associated with the targeted advertisement campaign; and
receiving, from the at least one targeted consumer device, receptiveness data associated with the targeted advertisement.

12. The method of claim 11 further comprising receiving target group information comprising at least one of household, geographical, demographic, psychographic, and location information.

13. The method of claim 11 further comprising generating rules associated with the targeted advertisement campaign from the target group information.

14. The method of claim 11 further comprising inserting a targeted advertisement into one of a banner advertisement on a webpage, video on demand, interactive advertisement on a webpage, short message service (SMS) messages, and email messages.

15. The method of claim 11 further comprising inserting a targeted advertisement into a video stream.

16. The method of claim 15 wherein the insertion of the targeted advertisement occurs at one of a video head office, a video service office, and a client device.

17. The method of claim 11 further comprising causing a client device to switch from receiving a broadcast over a linear broadcast channel to a targeted advertisement on a video on demand channel.

18. The method of claim 11 further comprising causing a client device to switch from receiving a broadcast over a linear broadcast channel to a targeted advertisement on a Internet Protocol (IP) channel.

19. The method of claim 11 wherein the receptiveness data includes at least one of a selection to watch a targeted advertisement, a request to create a bookmark for an associated target advertisement, a request for more information associated with a targeted advertisement.

20. A computer readable media comprising code to perform the acts of the method of claim 11.
